(19) United States
(12) Patent Application Publication
(10) Pub. No.: US 2026/0289974 A1
(43) Pub. Date: Sep. 24, 2026

(54) METHOD FOR TRAINING A MACHINE LEARNING MODEL FOR INSTANCE SEGMENTATION, TRAINED MACHINE LEARNING MODEL, DEVICE FOR INSTANCE SEGMENTATION, SYSTEM AND COMPUTER PROGRAM

(71) Applicant: Carl Zeiss Microscopy GmbH, Jena (DE)

(72) Inventors: Simon FRANCHINI, München (DE); Noah LATZEL, München (DE); Sebastian SOYER, München (DE); Sandra LEMKE, München (DE)

(21) Appl. No.: 19/570,792

(22) Filed: Mar. 18, 2026

(30) Foreign Application Priority Data
Mar. 24, 2025 (DE) 10 2025 111 291.6

(51) Int. Cl. G06V 10/774; G06V 10/26; G06V 10/764; G06V 10/776; G06V 20/69

(52) U.S. Cl. CPC G06V 10/774; G06V 10/26; G06V 10/764; G06V 10/776; G06V 20/695; G06V 20/698

(57) ABSTRACT

A method for training a machine learning model for instance segmentation of objects in images. The method uses specific components of a cost function in order to reduce the occurrence of object fragments. The specific components are referred to as query loss and overlapping loss. The method may operate on a training image, in which one or more objects to be segmented are annotated.

### RELATED APPLICATION DATA

This application claims the benefit of German Application No. 10 2025 111 291.6, filed Mar. 24, 2025, the content of which is incorporated herein by reference in its entirety.

### TECHNICAL FIELD

The present application relates to methods for training a machine learning model for instance segmentation of objects in images, correspondingly trained machine learning models, devices for instance segmentation with machine learning models trained in this way, systems comprising such devices, and corresponding computer programs.

### BACKGROUND

Instance segmentation is a computer vision task in which individual instances of objects within an image are identified and separated. A region or a boundary of each instance of objects is detected and each object of the same object class is individually identified. Unlike semantic segmentation, instance segmentation thus distinguishes between individual instances of objects of the same class.

Instance segmentation is usually performed with the aid of trained machine learning models. One application for such instance segmentation is microscopy, in which objects are intended to be identified in images recorded by way of a microscope. One example is microscope recordings of tissue samples in which specific types of cells, for example tumour cells, are to be detected.

One example of such machine learning logic is Mask R-CNN, described in K. He et al., “Mask R-CNN”, IEEE Transactions on Pattern Analysis and Machine Intelligence, vol. 42, no. 2, pp. 386-397, 1 Feb. 2020, where Mask R-CNN stands for Mask Region-based Convolutional Neural Network.

Convolutional neural networks are used here for instance segmentation.

A further approach is based on transformer-based architectures for query-based instance segmentation. Examples here are detections transformers (DETR), see e.g. N. Carion et al., “End-to-End object detection with Transformers”, Computer Vision-ECCV 2020, Mask Transformer, see e.g. B. Cheng et al., “Per pixel classification is not all you need for semantic segmentation”, NeurIPS 2021, or as a further development of this Mask2Former, B. Cheng et al, “Masked-attention Mask Transformer for Universal Image Segmentation”, CVPR 2022.

These procedures use a transformer-based encoder-decoder architecture and learnable object queries (referred to hereinafter as queries for short) in order to segment the objects in an image.

Traditionally, machine learning models for instance segmentation are trained by means of images in which at least one object of a specific object class is annotated. Partially annotated images can also be used, in which only an image region is annotated, but not the entire image. In this regard, DE102022209113A1, for example, describes a training of machine learning models for instance segmentation with partially annotated images, where objects and a background are annotated at least in a part of an image.

If such trained machine learning models are then used for inference, that is to say are used for segmenting images, it may be the case that fragments occur. Fragments are regions that are not related to the actual object and in reality do not belong to the object either, but are nevertheless recognized as part of the object during segmenting. This is illustrated in FIG. 1. In an image 10 in FIG. 1, an object 11 is recognized, but the area of the object 11 is not registered completely correctly, and fragments 12A and 12B outside the actual object boundaries are also recognized as being associated with the object. Such an error, that is to say the incorrect identification of fragments, is a false positive error, that is to say that something is recognized that is not present. Such an error can falsify a subsequent image evaluation, for example when counting objects or when determining areas of objects such as cells.

### SUMMARY

There is therefore a need to reduce the occurrence of such fragments.

In accordance with one embodiment, a computer-implemented method for training a machine learning model for instance segmentation of objects in images is provided, comprising:
providing a training image, in which one or more objects to be segmented are annotated,
segmenting the training image with m queries, m≥1, into n segmented objects, n≤m, wherein the segmenting yields class probability information and mask probability information for each of the n segmented objects, wherein the class probability information indicates to which class of objects the object assigned to the respective query during segmenting belongs and with what probability, and the mask probability information indicates which region of the training image belongs to a specific object, in particular the respectively segmented object, and with what probability,
assigning the segmented objects to the annotated objects with the aid of the class probability information and the mask probability information,
determining a value of a cost function on the basis of the class probability information and mask probability information, and
training the machine learning model on the basis of the value,
wherein the cost function has a component giving negative assessment if a segmented object is assigned to no annotated object and has mask probability information in a region of the training image, which region is annotated, above a predefined threshold value.

Such a component of the cost function can improve the training of the machine learning model, so that fewer fragments occur.

The region of the training image that is annotated can be a region in which the objects to be segmented are annotated, or else a region in which there is annotation that there are no objects (background). The entire training image can also be annotated.

This component of the cost function loss_{query} can be calculated in one example as:

$${loss}_{query} = - {\sum }_{q = 1}^{Q} {\sum }_{p = 1}^{P} {\sum }_{c = 1}^{C} y ( p ) ln ( 1 - p ( p , c , q ) ) .$$

The sums here are over Q segmented objects that have been assigned to no annotated object, all pixels, of the annotated region of the training image (here expressed as a sum over all pixels P and a function y(p) that is equal to 1 in the annotated region of the training image and otherwise zero) and all C object classes. p denotes the respective mask probability, and ln denotes the natural logarithm. For p=0, the logarithm function is 0. For values of p>0 there is a positive contribution (owing to the minus sign before the sums) to loss_{query}, so that the abovementioned threshold value here is zero, wherein the positive contribution increases as the probability p increases.

A machine learning model should be understood to mean a computer-implemented algorithm that uses techniques and components of machine learning to perform instance segmentation, here query-based instance segmentation. Examples of such machine learning models have already been explained in the introductory part.

If each query segments an object, m=n. If there are fewer objects than queries (the number of queries is often constant for a given model), n>m. Queries that do not segment an object can be discarded (e.g. if all class probabilities are below a threshold value) or assigned to a specific “no object” class.

The training image can be based on an actual image recording, for example using a microscope, or can also be a synthetically generated training image.

An annotation should be understood to mean a labelling that can be carried out for example by a user or else automatically, for example in the case of synthetic generation of training images.

Even if a single training image is mentioned above, it should be understood that the above methods can be carried out for a plurality of different training images in which corresponding objects to be segmented are annotated.

The method is computer-implemented, i.e., as is customary in the training of machine learning models, it takes place on a computer or a plurality of networked computers, each comprising one or more corresponding processors and being programmed accordingly.

Probability information indicates a probability quantitatively. The mask probability information can be specified in the form of a so-called mask logit, and the class probability information as a class logit. In the probability calculation, a logit refers to the natural logarithm of a chance, that is to say the probability divided by the counter-probability (if p is the probability that the object identified by the query belongs to a certain class, the class logit would be ln(p/1(−p)), where ln is the natural logarithm. If the probability is greater than 50% (p>0.5), the logit is greater than zero, and is equal to zero if the probability is exactly 50%, and if the probability is less than 50%. In this regard, when using logits, for example, zero can be used as a threshold, and an association with a class can be established for a class logit greater than zero, or an association with a respective object mask can be established for a mask logit for an image element, e.g. pixel, greater than zero. However, other threshold values or other representations of probability can also be used as probability information, with appropriately adapted threshold values.

The training on the basis of the value of the cost function can take place in an inherently conventional way, for example using gradient methods that involve minimizing the cost function. For this purpose, the method is essentially carried out repeatedly, wherein the machine learning model is adapted between the repetitions, for example by changes of weighting factors, in order to minimize the cost function.

The cost function can preferably have a further component giving negative assessment if for an image element a sum of items of mask probability information of different segmented objects is above a predefined further threshold value. In this case, n>1.

For example, this component lossₒᵥₑᵣₗₐₚ can be calculated as

$${loss}_{overlap} = \frac{{\sum }_{p = 1}^{P} loss\_per \_pixel}{P} , loss\_per \_pixel = \{ \begin{matrix}{\sum }_{q = 1}^{Q} {\sum }_{c = 1}^{C} p ( p , c , q ) if {\sum }_{q = 1}^{Q} {\sum }_{c = 1}^{C} p ( p , c , q ) \geq threshold value \\ 0 if {\sum }_{q = 1}^{Q} {\sum }_{c = 1}^{C} p ( p , c , q ) < threshold value\end{matrix} .$$

The nomenclature is as in the above calculation of loss_{query}. As it were negative assessment is thus given here if a plurality of different objects may be situated at the same location in accordance with the mask probability information. The image element can be a pixel (picture element) or else a group of pixels. This can further reduce the occurrence of fragments.

This further component can also be provided independently of the component mentioned above and can also be applied to non-query-based methods for instance segmentation, since here as well a plurality of segmented objects may overlap incorrectly. In accordance with another exemplary embodiment, therefore, a method for training a machine learning model for instance segmentation of objects in images is provided, comprising:
providing a training image, in which one or more objects to be segmented are annotated,
segmenting the training image into n segmented objects, n>1, wherein the segmenting yields class probability information and mask probability information for each of the n segmented objects, wherein the class probability information indicates to which class of objects the respectively segmented object belongs and with what probability, and the mask probability information indicates which region of the training image belongs to the respectively segmented object and with what probability,
determining a value of a cost function on the basis of the class probability information and mask probability information, and
training the machine learning model on the basis of the value,
wherein the cost function has a component giving negative assessment if for an image element a sum of items of mask probability information of different segmented objects is above a predefined threshold value.

The machine learning model can be a transformer-based machine learning model, wherein segmenting the training image into n segmented objects comprises segmenting with n queries. For this purpose, inherently known machine learning models such as the above-described DETR architecture or Mask2Former can be used.

The above components of cost functions can be in particular a supplementation for conventionally used components of cost functions, such as label loss, mask loss and/or dice loss. The label loss essentially assesses an erroneous class assignment negatively, that is to say if the class probability information indicates an object class that does not match the object class of an assigned annotated object, the mask loss assesses an inaccurate mask negatively, that is to say if a contour does not match the contour of the annotated object according to the mask probability information, and the dice loss takes into account cases where the annotated objects constitute only a small part of the total area. Such components of cost functions are also used conventionally for training and are therefore not explained in more specific detail here.

Furthermore, a machine learning model for instance segmentation of objects is provided, said machine learning model being trained using the above method.

Furthermore, a device is provided which has an input for receiving images and also a processor configured to carry out an instance segmentation of objects in the images by means of the trained machine learning model. A system comprising such a device and an image recording device for recording the images is also provided, wherein the image recording device can comprise a microscope.

A computer program comprising a program code is also provided, which is designed to provide the above method for training a machine learning model when implemented on a processor. The computer program can be provided on a storage medium, in particular a physical storage medium such as a memory, a CD-ROM, one or more hard disks or the like. The trained machine learning model can also be provided on such a storage medium.

### BRIEF DESCRIPTION OF THE DRAWINGS

FIG. 1 is an exemplary image for illustrating a fragmentation.

FIG. 2 is a flowchart of a method in accordance with one exemplary embodiment.

FIG. 3 is a block diagram in accordance with one exemplary embodiment.

FIG. 4 is a diagram of a machine learning model that can be used in exemplary embodiments.

### DETAILED DESCRIPTION

Embodiments are explained in detail below. These embodiments should not be construed as restrictive but rather merely serve for elucidation purposes.

Features of different embodiments can be combined with one another, unless indicated otherwise. Variations, details and the like that are described for one embodiment are also applicable to other embodiments and are therefore not described repeatedly.

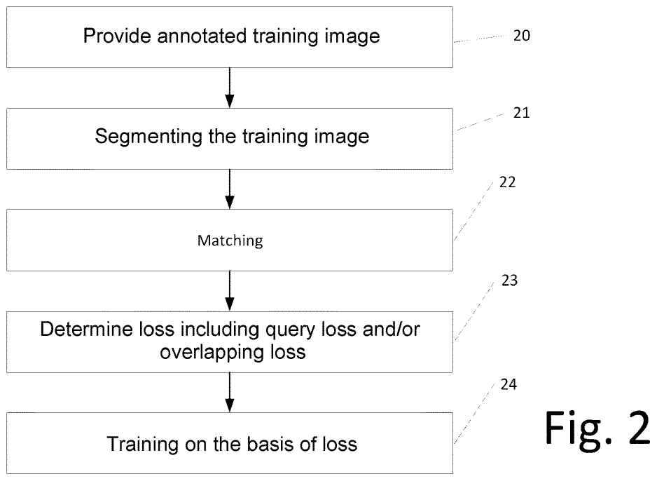

FIG. 2 shows a flowchart of a method in accordance with one embodiment.

Step 20 involves providing an annotated training image, that is to say a training image in which objects that are intended to be segmented by a machine learning model are annotated. An annotation should be understood to mean a labelling of the object. Such a labelling can be carried out for example manually by a human or by other possibilities for image recognition. In this case, a real recorded image can be used as the training image. Training images can also be generated synthetically. In this case, the annotation can be performed automatically in the course of generating the training images.

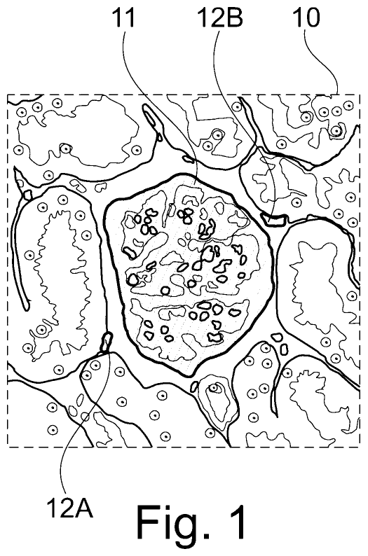

If the image in FIG. 1 is used as a training image, the object 11 can be annotated, for example. Training images can also be partially annotated, that is to say that there are annotations only in a part of the training image. A procedure for such partial annotation is described in DE102022209113A1, for example.

In step 21, the training image is segmented. For this purpose, for example, a query-based segmentation with m queries can be used to obtain n segmented objects, where n≤m, since as discussed above, some queries also do not segment objects (depending on the number of objects present in the image) and are then discarded or assigned to a “no object” class, as described above. These segmented objects each have class probability information and mask probability information, for example in the form of class logits and mask logits. Other procedures for segmentation can also be used.

In step 22, firstly a matching algorithm such as a “Hungarian matching” is carried out in order to assign each object annotated in the training image to a respective query in a 1:1 matching. Each annotated object is assigned to that query which simultaneously has the most precise object mask and the highest probability of association with the object class of the annotated object. For example, the object 11 in FIG. 1 can be a segmented object, which is then assigned to a corresponding annotated object.

A matching algorithm is generally an algorithm whose main task is to optimally assign the objects predicted by the model (according to the class probability information and the mask probability information) to the actual, that is to say annotated, objects in the training image. Since the machine learning model makes a fixed number of object predictions (n queries), it is necessary to decide which prediction corresponds to which annotated object. Matching algorithms such as the Hungarian matcher solve this assignment problem by minimizing a cost function that takes into account various variables, in particular the accuracy of the assignment to the region of the object on the basis of the mask probability information and the class assignment to the object on the basis of the class probability information.

Step 23 then involves determining a value of a cost function, usually referred to as loss. In the illustrated embodiment, the loss function has specific components, namely a component designated as query loss and a component designated as overlapping loss. Query loss and overlapping loss can be used jointly, but also separately. Query loss is a component that punishes if a segmented object from step 21 is assigned to no annotated object in step 22, but has mask probability information above a threshold value in annotated regions (either annotated as object or annotated as background) in the training image. If logits are used, the threshold value can be zero, so that positive mask logits are negatively assessed here. For example, in such cases, the query loss can be increased, and the goal of the training is then to minimize the cost function. This can contribute to reducing false positive predictions such as object fragments by unassigned segmented objects, for example unassigned queries.

Overlapping loss gives negative assessment if the sum of all items of mask probability information of the segmented objects for an image element (for example pixel or groups of pixels) is above a further predefined threshold value. Here, too, in the event of the threshold being exceeded, the value of the cost function can be increased if the training described below is aimed at minimizing the cost function. This has the effect of punishing, in training, overlapping object regions, in particular object fragments, that are situated in the region of other objects. In addition, it is thus also possible to optimize queries without reference to the annotated region, which can prevent the occurrence of object fragments altogether. This means that, as long as it is assumed that objects cannot overlap, this component of the cost function can also be applied in unannotated regions.

In addition to these components, the cost function can also include conventional components such as label loss, mask loss, dice loss and the like.

Step 24 then involves carrying out a training on the basis of the loss, for example by means of gradient methods, in which the machine learning model is adapted step by step in order to minimize the loss.

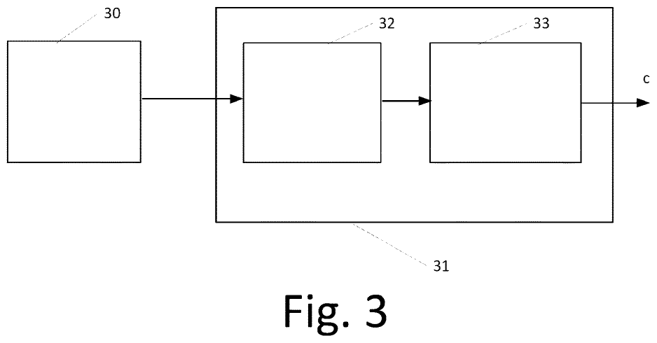

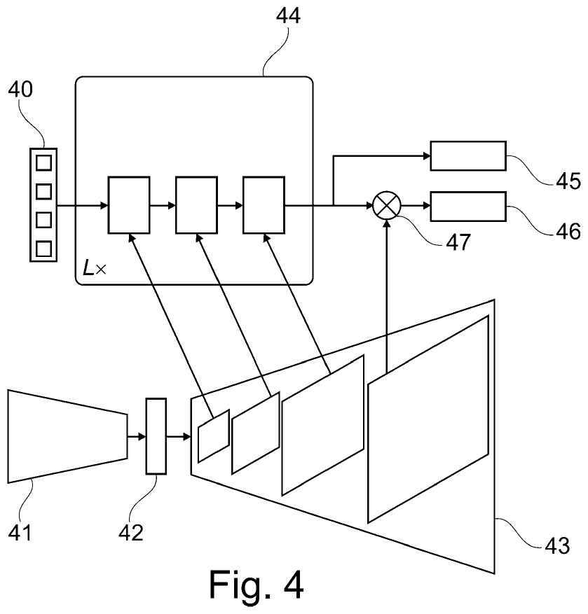

Systems and possible machine learning models will now be briefly discussed with reference to FIGS. 3 and 4. However, the method in FIG. 2 is generally applicable to machine learning models for instance segmentation, and so the systems and machine learning models in FIGS. 3 and 4 serve merely as an example.

FIG. 3 shows a system in accordance with one exemplary embodiment. The system in FIG. 3 shows an image recording device for supplying images in which objects are to be segmented. For this purpose, the image recording device can contain one or more cameras. The image recording device can also contain a microscope, wherein the images are then recorded through the microscope using a camera, for example. For other types of microscopes, e.g. laser scanner microscopes, scanning of a sample can also be effected in order to obtain images. For example, images of tissue samples can be recorded using such microscopes. Furthermore, the system has a computing device 31, on which a machine learning model 32, 33 runs. The machine learning model 32, 33 has two stages 32 and 33 in the example illustrated. The machine learning model is trained using the methods described herein and can then be used as a trained machine learning model for inference. For example, a first stage 32 can be used for preprocessing, and a second stage 33 can contain a transformer, which then generates a classification c. As explained in the introduction, the machine learning model can be designed for query-based instance segmentation can be a DETR-based model or a Mask2Former model. However, non-transformer-based machine learning models such as the Mask R-CNN architecture mentioned above are also possible.

As an example of a machine learning model, FIG. 4 illustrates the Mask2Former model according to Cheng et al, “Masked-attention Mask Transformer for Universal Image Segmentation”, as already cited above. Apart from the training described here, which leads to a correspondingly trained model, the model in FIG. 4 can be executed in a conventional manner and will therefore only be described briefly. Images (training images during training and images to be analysed during inference) are fed to a backbone 41, which can be implemented for example as a neural network and is designed to extract features with low resolution 42. The images can also be 3D images, and the backbone 41 can extract 2D features from them. These features are then upscaled in a pixel decoder. A transformer decoder 44 obtains the image data conditioned by the pixel decoder 43 and also a multiplicity of queries 40, to which it then assigns class probability information 45, for example in the form of class logits, and mask probability information 46 (via a combination 47 with the image data supplied by the pixel decoder 43), for example in the form of mask logits. The class probability information 45 indicates to which object class a query is assigned, and the mask probability information 46 indicates the corresponding image region.

What is claimed is:

1. A computer-implemented method for training a machine learning model for query-based instance segmentation of objects in images, comprising:
providing a training image, in which one or more objects to be segmented are annotated,
segmenting the training image with m queries, m≥1, into n segmented objects, n≤m, wherein the segmenting yields class probability information and mask probability information for each of the n segmented objects, wherein the class probability information indicates to which class of objects the object assigned to the respective query during segmenting belongs and with what probability, and the mask probability information indicates which region of the training image belongs to a specific object and with what probability,
assigning the segmented objects to the annotated objects with the aid of the class probability information and the mask probability information,
determining a value of a cost function on the basis of the class probability information and mask probability information, and
training the machine learning model on the basis of the value,
wherein the cost function has a component giving negative assessment if a segmented object is assigned to no annotated object and has mask probability information in a region of the training image, which region is annotated, above a predefined threshold value.

2. The method according to claim 1, wherein n>1, wherein the cost function has a further component giving negative assessment if for an image element of the training image a sum of items of mask probability information of different segmented objects is above a predefined further threshold value.

3. The method according to claim 1, wherein the machine learning model is a transformer-based machine learning model for query-based instance segmentation.

4. The method according to claim 1, wherein the cost function comprises one or more further components selected from the group consisting of label loss, mask loss and dice loss.

5. A non-transitory computer readably medium storing a machine learning model for instance segmentation of objects in images, trained using the method according to claim 1.

6. A device for instance segmentation of objects in images, comprising:
an input for receiving an image, and
a processor configured to segment objects in the received image by means of the machine learning model of claim 5.

7. A system, comprising:
an image recording device for recording an image, and
the device according to claim 6, wherein the input of the device is coupled to the image recording device in order to receive the recorded image.

8. The system according to claim 7, wherein the image recording device comprises a microscope.

9. A non-transitory computer readably medium storing computer program comprising a program code designed to carry out the method according to claim 1 when executed on a processor.

10. A method for training a machine learning model for instance segmentation of objects in images, comprising:
providing a training image, in which one or more objects to be segmented are annotated,
segmenting the training image into n segmented objects, n>1, wherein the segmenting yields class probability information and mask probability information for each of the n segmented objects, wherein the class probability information indicates to which class of objects the respectively segmented object belongs and with what probability, and the mask probability information indicates which region of the training image belongs to the respectively segmented object and with what probability,
assigning the segmented objects to the annotated objects with the aid of the class probability information and the mask probability information,
determining a value of a cost function on the basis of the class probability information and mask probability information, and
training the machine learning model on the basis of the value,
wherein the cost function has a component giving negative assessment if for an image element a sum of items of mask probability information of different segmented objects is above a predefined threshold value.

11. A non-transitory computer readably medium storing a machine learning model for instance segmentation of objects in images, trained using the method according to claim 10.

12. A device for instance segmentation of objects in images, comprising:
an input for receiving an image, and
a processor configured to segment objects in the received image by means of the machine learning model of claim 11.

13. A system, comprising:
an image recording device for recording an image, and
the device according to claim 12, wherein the input of the device is coupled to the image recording device in order to receive the recorded image.

14. The system according to claim 13, wherein the image recording device comprises a microscope.

15. A non-transitory computer readably medium storing computer program comprising a program code designed to carry out the method according to claim 10 when executed on a processor.
